(19) United States
(12) Patent Application Publication
(10) Pub. No.: US 2026/0092482 A1
(43) Pub. Date: Apr. 2, 2026

(54) TRANSLATIONAL-ROTATIONAL FITTING AND FURNITURE OR HOUSEHOLD APPLIANCE ELEMENT

(71) Applicant: PAUL HETTICH GMBH & CO. KG, Kirchlengern (DE)

(72) Inventors: Frank BAUERRICHTER, Löhne (DE); Andreas MONTECCHIO, Bad Salzuflen (DE); Guido LIMBERG, Bad Salzuflen (DE); Christian KOPTIK, Gütersloh (DE); David KRÜGER, Hannover (DE); Sören KLÜTER, Bad Oeynhausen (DE); Niklas VISCHER, Herford (DE)

(21) Appl. No.: 19/113,180

(22) PCT Filed: Sep. 19, 2023
(86) PCT No.: PCT/EP2023/075753

§ 371 Date: Mar. 19, 2025

(30) Foreign Application Priority Data
Sep. 20, 2022 (DE) 10 2022 124 143.2

(51) Int. Cl. E05D 7/04; E05D 3/18

(52) U.S. Cl. CPC E05D 7/0407; E05D 3/18; E05D 2007/0484

(57) ABSTRACT

A translational-rotational fitting for the at least partially positively guided simultaneous translational-rotational movement of a first body relative to a second body in one of two possible opposite directions of rotation and in a predetermined direction of translation has a first fitting plate coupled to the first body and a second fitting plate coupled to the second body, which is simultaneously movable in translation and rotation relative to the first fitting plate. At least one adjustment arrangement is fixed displaceably on the first fitting plate for independent alignment of the first fitting plate relative to the first body in two mutually perpendicular adjusting directions in the plane of the first body by a limited adjustment dimension.

### BACKGROUND AND SUMMARY OF THE INVENTION

Exemplary embodiments of the present invention relate to a translational-rotational fitting and to a furniture or household appliance element.

Generic translational-rotational fittings are known, for example, from DE 10 2019 109 866 A1 and are used in particular for the simultaneous translational and rotational movement of a first body relative to a body, for example in the form of a shelf accommodated in a furniture body.

The translational-rotational fitting described there has proven itself in practice. The fitting plates of the translational-rotational fitting must be attached very precisely to the first or second body to ensure collision-free movement of the second body relative to the first body within the available installation space and also to ensure an exact joint pattern when two or more such bodies are arranged over a translational-rotational fitting.

Exemplary embodiments of the present invention are directed to a translational-rotational fitting with which alignment in the horizontal plane is also possible in a simple manner at a later date.

A translational-rotational fitting according to the invention for the at least partially positively guided simultaneous translational-rotational movement of a first body relative to a second body in one of two possible opposite directions of rotation and in a predetermined direction of translation has a first fitting plate coupled to the first body and a second fitting plate coupled to the second body, which can be moved simultaneously in translation and rotation relative to the first fitting plate. At least one displaceably fixed adjustment arrangement is provided on the first fitting plate for independent alignment of the first fitting plate relative to the first body in two mutually perpendicular adjusting directions in the plane of the translational-rotational movement of the first body relative to the second body by a limited adjustment dimension.

With such a displaceably fixed adjustment arrangement, alignment in the horizontal plane is made possible in a simple manner even after installation of the translational-rotational fitting between the first and second body.

The adjustment arrangement can be designed differently.

Thus, according to an advantageous embodiment, the adjustment arrangement has a sliding element, which is held on the first body so as to be displaceable in the first adjusting direction and which is held on the first fitting plate so as to be displaceable in the second adjusting direction. Furthermore, the adjustment arrangement has at least two adjusting units for adjusting the first fitting plate in the first adjusting direction and the second adjusting direction.

According to a preferred further development, the sliding element is designed as a base plate with a plurality of first elongated holes aligned in the first adjusting direction and a plurality of second elongated holes aligned in the second adjusting direction, wherein first retaining elements fastened to the first body are guided through the first elongated holes and second retaining elements fastened to the first fitting plate are guided through the second elongated holes, which are designed in particular as bolts or screws.

With such a sliding element designed as a base plate, the first fitting plate can be easily adjusted together with the base plate relative to the first body in a first adjusting direction and can be adjusted relative to the base plate itself in the second adjusting direction.

According to a preferred further development, the base plate has a first collar with a threaded bore in operative connection with the first adjusting unit and aligned perpendicularly to the first actuating direction, and a second collar with a threaded bore in operative connection with the second adjusting unit and aligned perpendicularly to the second actuating direction, wherein a first adjusting screw held in a fixed position on the first body is received in the threaded bore of the first collar and a second adjusting screw held in a fixed position on the first fitting plate is received in the threaded bore of the second collar.

For vertical fixing of the translational-rotational fitting to the first body, the adjustment arrangement according to a further preferred embodiment has a first holder and a second holder, which are positioned between the base plate and the first fitting plate and serve for displaceable mounting of the base plate on the first body, wherein the first holder has a stop for stationary but rotatable mounting of the first adjusting screw.

According to an alternative embodiment, the sliding element is designed as a guide cross with a first web aligned in the first actuating direction and a second web aligned in the second actuating direction. The first web is slidably accommodated in a groove of a base plate attached to the first body in the first positioning direction and the second web is guided in a groove of a sliding plate attached to the first fitting plate.

According to a preferred further development, the two actuators are fixed to the base plate and the sliding plate.

According to another further development, the adjusting units have two adjusting elements connected to each other by a respective adjusting screw, the distance between which can be adjusted by turning the adjusting screw.

The groove of the sliding plate is covered towards the first fitting plate with a cover plate attached to the base plate, thereby protecting it from dust or dirt in particular.

According to a further alternative embodiment, the adjustment arrangement has two first L-shaped sliding elements held on the first body so as to be displaceable in the first adjusting direction and two second L-shaped sliding elements held on the first body so as to be displaceable in the second adjusting direction, the first sliding elements being aligned perpendicular to the second sliding elements.

An adjustment arrangement designed in this way also makes it easy to align the first fitting plate relative to the first body.

According to an advantageous further development of this design variant, the sliding elements are slidably mounted in retaining elements attached to the first body by means of adjusting screws.

The adjusting screws are designed, for example, as eccentric screws that protrude into elongated holes in a leg of the sliding elements that protrudes into the respective retaining element.

In all of the design variants of translational-rotational fittings described so far, the first fitting plate and the second fitting plate of the translational-rotational fitting each have running grooves facing bearing surfaces in which rolling elements are guided for simultaneous translational-rotational movement.

According to a further alternative embodiment, the sliding element is designed as a guide cross with a first web aligned in the first actuating direction and a second web aligned in the second actuating direction, wherein the first web is received in a groove of a base plate attached to the first body so as to be displaceable in the first actuating direction and the second web is guided in a groove of the first fitting plate.

This design variant is particularly suitable for a translational-rotational fitting in which a guide element is arranged on the first fitting plate for simultaneous translational-rotational movement, which can be moved in a curved guide track arranged on or in the second plate. The design variants described above can also be used for a translational-rotational fitting with a guide element and a curved guide track.

According to a preferred further development of this design variant of the translational-rotational fitting, the adjusting units have two adjusting bodies connected to one another by a respective adjusting screw, the distance between which can be adjusted by turning the adjusting screw, a first adjusting body being attached to the first fitting plate and a second adjusting body being attached to the base plate and the adjusting screws being aligned orthogonally to one another.

According to a further preferred further development, the base plate and the first fitting plate have respective guide slots for receiving rivets fixing the base plate and the first fitting plate to one another in a direction perpendicular to the plane of the base plate, which extend in one of the setting directions, wherein partially overlapping guide slots are aligned in different ones of the setting directions in each case.

A furniture or household appliance element according to the invention has a first body and a second body movable relative thereto and a translational-rotational fitting by means of which the second body can be moved relative to the first body in a predetermined direction of translation and simultaneously in one of two possible opposite directions of rotation, the translational-rotational fitting being designed as described above.

### BRIEF DESCRIPTION OF THE DRAWING FIGURES

Preferred embodiments are explained in more detail below with reference to the accompanying drawings, wherein:

FIG. 1 shows a schematic isometric representation of a translational-rotational fitting arranged between a first body and a second body,

FIG. 2 shows an isometric exploded view of the arrangement shown in FIG. 1,

FIG. 3 shows an isometric representation of the first fitting plate fixed to the first body and the first embodiment of an adjustment arrangement with a sliding element designed as a base plate,

FIG. 4 shows a view of the translational-rotational fitting according to FIGS. 1-3 from the hidden first body,

FIG. 5a-5c show enlarged views of FIG. 4 to show different adjustment positions of the sliding element,

FIG. 6a-6d show side views of the translational-rotational fitting according to FIG. 2-4 to show different positioning positions,

FIG. 7 shows an isometric representation, corresponding to FIG. 2, of an alternative embodiment of a translational-rotational fitting arranged between the first body and the second body with an alternatively designed adjustment arrangement with a sliding element designed as a guide cross,

FIG. 8 shows a schematic top view of the adjustment arrangement shown in FIG. 7,

FIGS. 9a and 9b show isometric views of an embodiment of a positioning unit,

FIG. 10 shows an illustration, corresponding to FIG. 3, of a further embodiment of a translational-rotational fitting according to the invention with L-shaped sliding elements as part of the adjustment arrangement, attached to the first body,

FIG. 11a-c shows a top view of the sliding elements, inserted into receptacles on the underside of the first fitting plate facing the first body in different setting positions,

FIG. 12a-12e show principle illustrations of different adjustment positions of the L-shaped sliding elements and the adjusting screws that set the adjustment position,

FIGS. 13a and 13b show isometric representations of an embodiment variant with adjusting screws designed as eccentric screws, which engage in elongated holes of a respective leg of the L-shaped sliding elements,

FIG. 14 shows a top view of a further embodiment of a translational-rotational fitting according to the invention with a sliding element also designed as a guide cross,

FIG. 15 shows an isometric representation of the translational-rotational fitting corresponding to FIG. 2, and

FIG. 16a and FIG. 16b show the translational-rotational fitting in different setting positions as shown in FIG. 14.

### DETAILED DESCRIPTION

In the following description of the figures, terms such as top, bottom, left, right, front, rear, etc. refer exclusively to the exemplary representation and position of the translational-rotational fitting, base plate, holder, sliding plate, guide cross and the like selected in the respective figures. These terms are not to be understood restrictively, i.e. these references may change due to different working positions or the mirror-symmetrical design or the like.

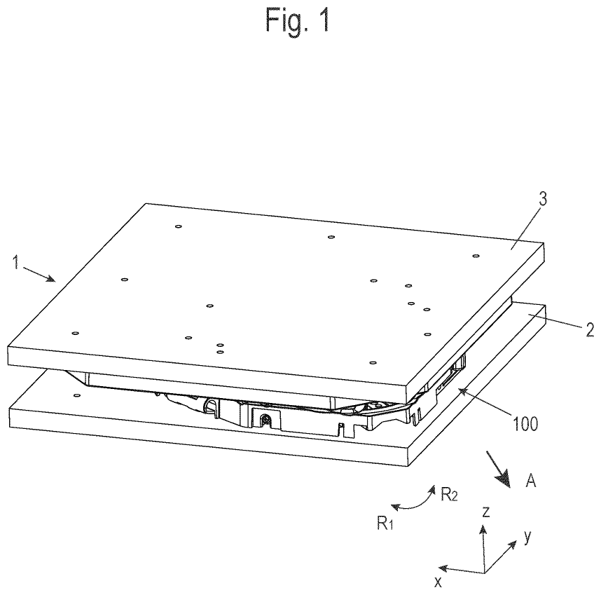

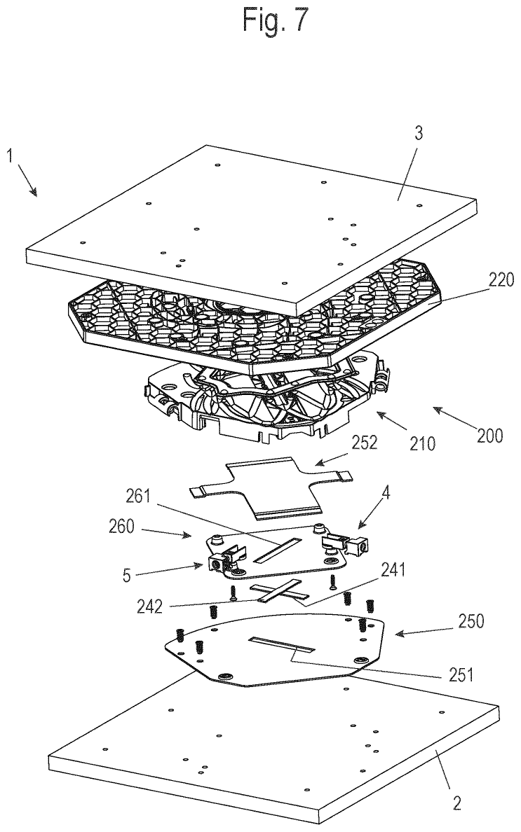

In FIGS. 1 and 7, the reference sign 1 designates a furniture or household appliance element 1 as a whole, which here consists of a first body 2, a second body 3 and a translational-rotational fitting 100 arranged between the first and second bodies. As shown in FIGS. 1 and 7, the first body 2 can be a support plate or a section of the base of a cupboard or shelving unit. A corresponding furniture element is shown, for example, in DE 10 2019 109 866 A1.

Accordingly, the second body 3 can also be realized as a panel. However, it is also conceivable here for the second body 3 to be designed as a shelf furniture element that has several shelves or storage compartments vertically above one another.

It is important that the second body 3 can be moved relative to the first body 2 in a partially constrained simultaneous translational-rotational movement relative to the first body 2, namely in one of two possible opposite directions of rotation R1, R2 and in a predetermined direction of translation A, as is also described by way of example in DE 10 2019 109 866 A1 mentioned at the beginning.

FIGS. 1-16b show several embodiments of translational-rotational fittings 100, 200, 300, 400. All of these translational-rotational fittings 100, 200, 300, 400 have in common that they have a first fitting plate 110, 210, 310, 410 coupled to the first body 2 and a second fitting plate 120, 220, 420 coupled to the second body 3. An adjustment arrangement is displaceably fixed to the first fitting plate 110, 210, 310, 410, which serves to independently align the first fitting plate 110, 210, 310, 410 relative to the first body 2 in two mutually perpendicular adjusting directions x, y in the plane of the first body 2, usually a horizontal plane, by a limited adjustment dimension.

A first embodiment of a translational-rotational fitting 100 is shown in FIGS. 1-6d.

In this embodiment, the two fitting plates 110, 120 each have running grooves 112, 122 in mutually facing bearing surfaces for simultaneous translational-rotational movement, in which rolling elements 131 are guided. In the embodiment variant shown here, the rolling elements 131 are designed as balls, which are held in a rolling element cage 130 to prevent loss. It is also conceivable for the rolling elements to be designed as ball rollers with a cylindrical housing and a ball mounted therein or the like.

In addition to the design of the running grooves 112, 122, the predetermined direction of translation A is guided by a guide pin 113, which is held stationary but rotatable in the second fitting plate 120 and which is linearly movable on a carriage 114 guided in a longitudinal groove of the first fitting plate 110.

The adjustment arrangement, which serves to precisely align the first fitting plate 110 relative to the first body 2, has a sliding element which is held on the first body 2 so as to be displaceable in the first adjusting direction x and which is held on the first fitting plate 110 so as to be displaceable in the second adjusting direction y, as well as at least two adjusting units 4, 5 for adjusting the first fitting plate 110 in the first adjusting direction x and the second adjusting direction y.

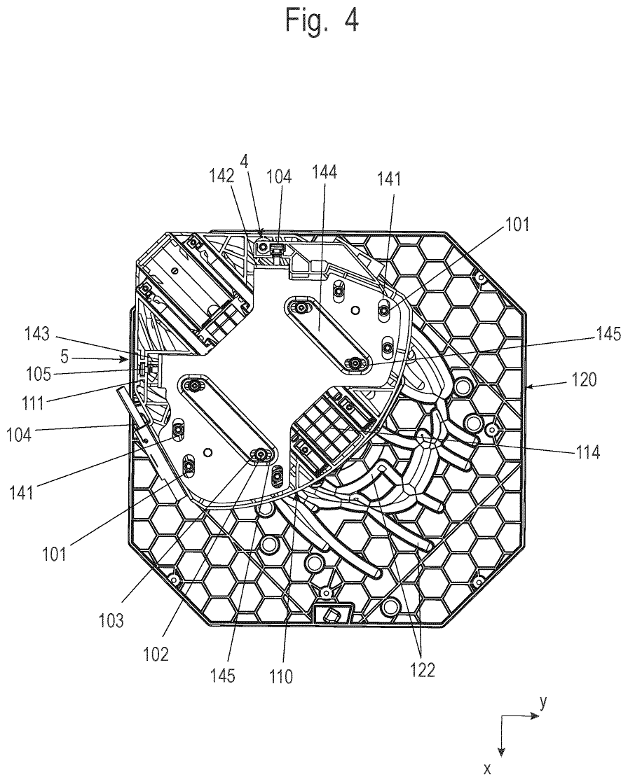

In the embodiment of the translational-rotational fitting 100 shown in FIGS. 1-6d, the sliding element is designed as a base plate 140. The base plate 140 has a plurality of first elongated holes 141 aligned in the first positioning direction x and a plurality of second elongated holes 145 aligned in the second positioning direction y, as can be clearly seen, for example, in the view of the translational-rotational fitting 100 from below shown in FIG. 4 with the first body 2 hidden.

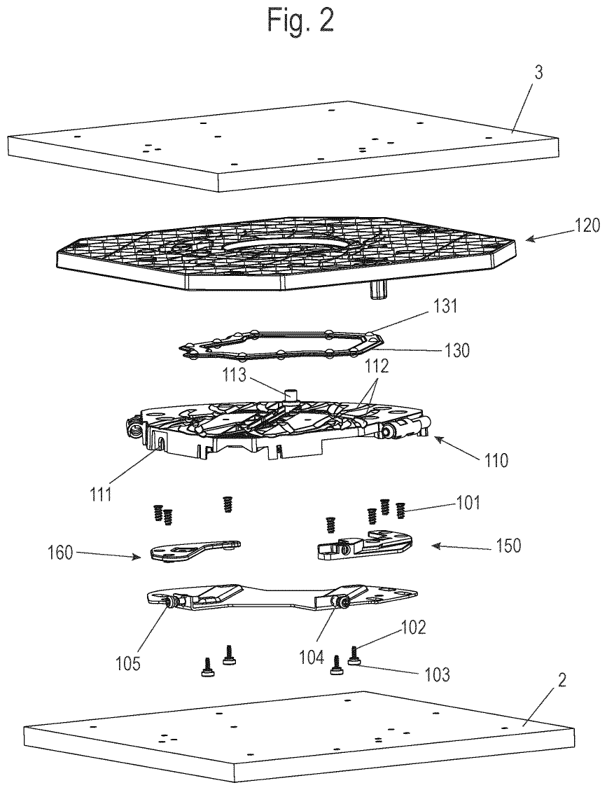

First retaining elements 101 attached to the first body 2 are guided through the first elongated holes 141. Second retaining elements 102 attached to the first fitting plate 110 are guided through the second elongated holes 145. The retaining elements 101 and the retaining elements 102 are designed, in particular, as bolts or screws, as shown by way of example in FIG. 2. The elongated holes 145 are preferably provided in the region of a bulge 144 of the base plate 140 in order to be able to accommodate heads 103 of the retaining elements 102 above the upper side of the first body 2 facing the base plate 140.

In the embodiment shown here, the adjusting units 4, 5, with which the first fitting plate 110 can be aligned or adjusted relative to the first body 2, comprise a first collar 142 and a second collar 143, which are bent over from the plane of the base plate 140 in the z-direction perpendicular to the plane of the base plate 140, and a respective first adjusting screw 104 and second adjusting screw 105.

The first collar 142, which is aligned perpendicular to the first adjusting direction x, and the second collar 143, which is aligned perpendicular to the second adjusting direction y, each have a threaded bore, which engages with the thread of the respective first adjusting screw 104 or second adjusting screw 105.

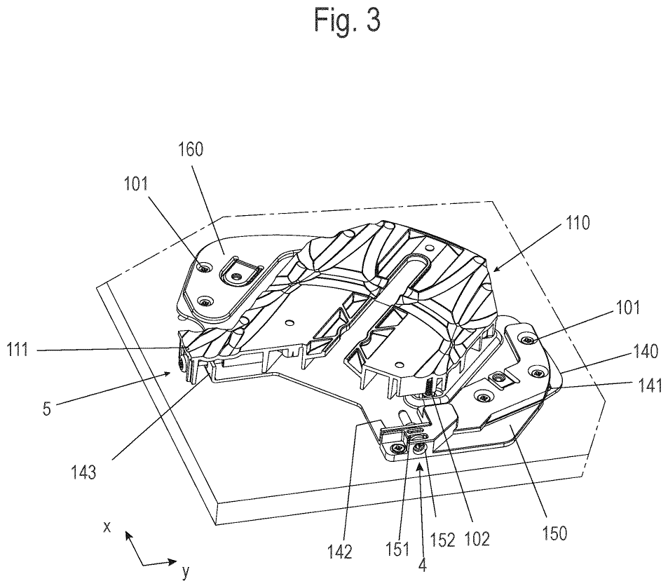

A head or collar piece of the first adjusting screw 104 is fixed in a stationary but rotatable manner on the first body 2. This fixation takes place here via a first holder 150 of the adjustment arrangement, which is positioned between the base plate 140 and the first fitting plate 110 and serves to displaceably hold the base plate 140 on the first body 2. As can be clearly seen in FIG. 3, a stop 151 with a through-hole 152 accessible from a lateral edge is arranged in this holder 150.

The first holder 150 and a second holder 160, also shown in FIGS. 2 and 3, are fixed to the first body 2 by means of the first retaining elements 101. By turning the first adjusting screw 104, the base plate 140 can thus be adjusted in the x-direction relative to the first holder 150 and thus relative to the first body 2 by an adjustment dimension that is essentially limited by the extent of the threaded section of the first adjusting screw 104 in the x-direction.

The second adjusting screw 105 is held by its head or a collar piece on a collar 111 of the first fitting plate 110, which extends vertically, i.e., in the z-direction, in a stationary but rotatable manner. By turning the second adjusting screw 105, this collar 111 is thus drawn towards or moved away from the second collar 143 of the base plate 140 in the y-direction.

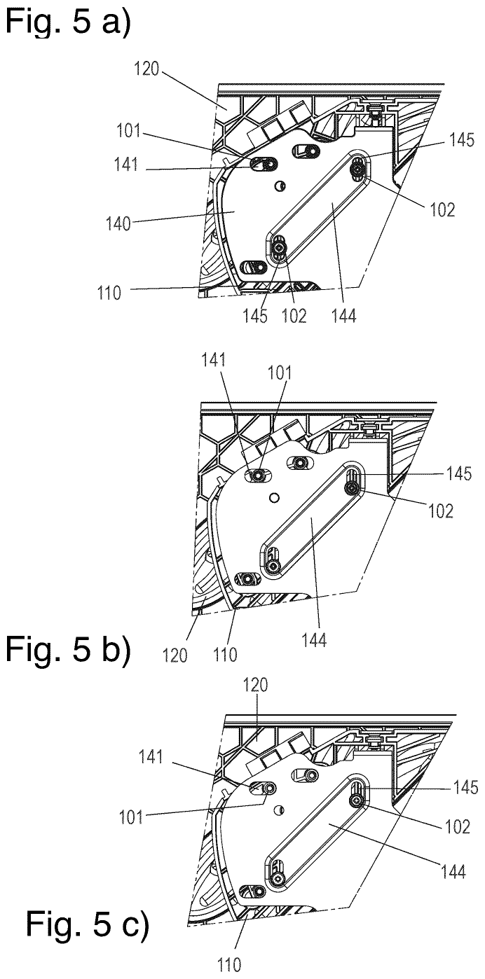

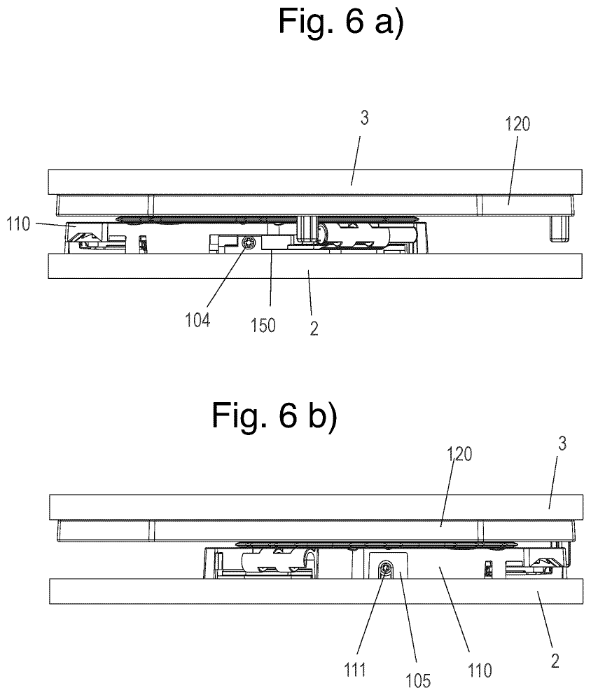

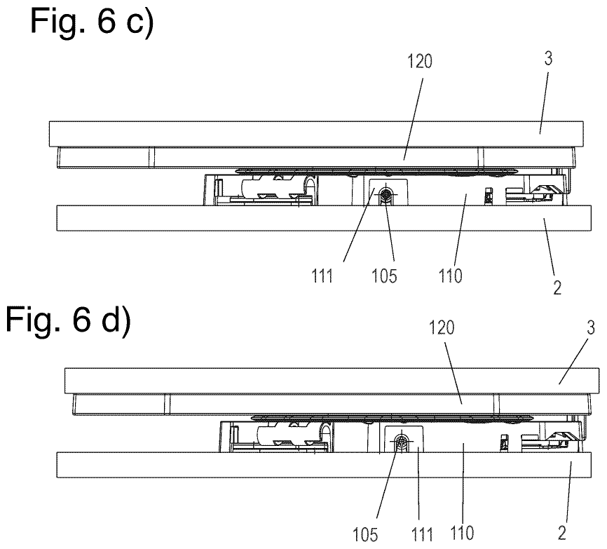

FIGS. 5a-5c and 6a-6d show different positioning of the first fitting plate 110 relative to the first body 2. In FIGS. 5a-5c, the relative position is shown in the top view of the base plate corresponding to FIG. 4 from the side of the first body 2. Thus, FIG. 5a shows a position displaced from a neutral position in the y-direction, while the orientation in the x-direction is neutral.

FIG. 5b shows a neutral y-position and a maximum displacement of the first fitting plate 110 in the x-direction.

FIG. 5c shows a maximum displacement of the first fitting plate 110 in both the x and y directions.

In the side views in FIGS. 6a-6d, FIG. 6a shows a neutral position with the first body 2 and second body 3 arranged exactly one above the other, while FIGS. 6b-6d show different displacement positions.

In the second embodiment of a translational-rotational fitting 200 according to the invention shown in FIGS. 7-9, the actual translational-rotational fitting with first fitting plate 210 and second fitting plate 220 and rolling elements arranged therebetween is identical to the embodiment described with reference to FIGS. 1-6.

The adjustment arrangement also has a sliding element here, which in this case is designed as a guide cross 240.

The guide cross 240 has a first web 241 aligned in the first positioning direction x and a second web 242 aligned in the second positioning direction y. The two webs 241, 242 are preferably bonded or welded together or manufactured in one piece.

The first web 241 is received in a groove 251 of a base plate 250 attached to the first body 2 so as to be displaceable in the first adjusting direction x. The second web 242 is guided in a groove 261 of a sliding plate 260 attached to the first fitting plate 210.

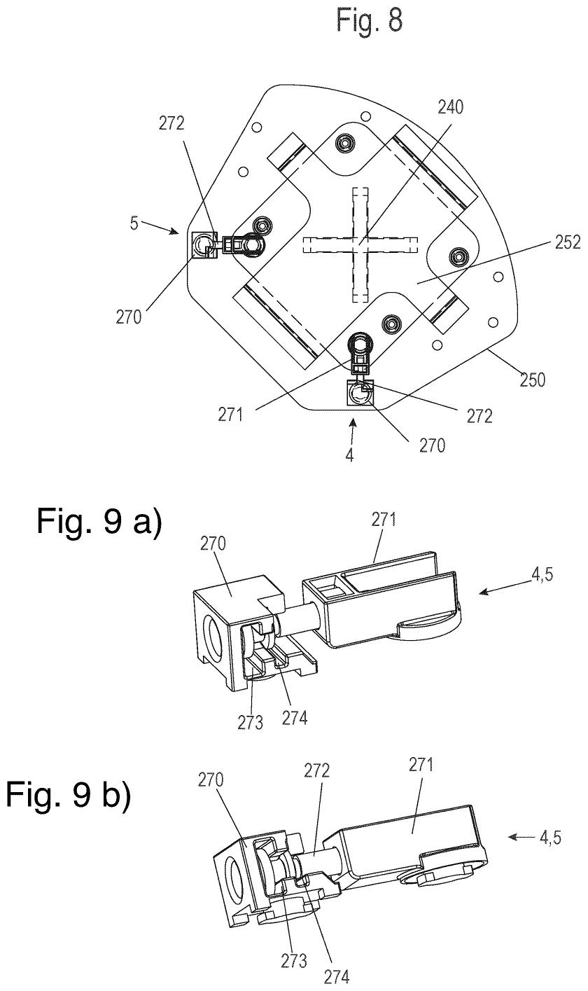

The adjusting units 4, 5 preferably used in this embodiment consist here of two adjusting bodies 270, 271 connected to one another by a respective adjusting screw 272, the distance between which can be adjusted by turning the adjusting screw 272. As shown in FIGS. 7 and 8, the two adjusting units 4, 5 are fixed here with their first adjusting body 270 to the base plate 250 and with the second adjusting body 271 to the sliding plate 260.

Preferably, the groove 261 and the second web 242 of the guide cross 240 received therein is covered with respect to the first fitting plate 210 by a cover plate 252, which is fixed to the base plate 250 via two fixing arms.

As shown in FIGS. 9a and 9b, the first adjusting body 270 has two grooves 273, 274, which serve to fix the adjusting screw 272 in a stationary but rotatable manner. By turning the adjusting screw 272, the second adjusting body 271 is thus pulled towards or moved away relative to the first adjusting body 270.

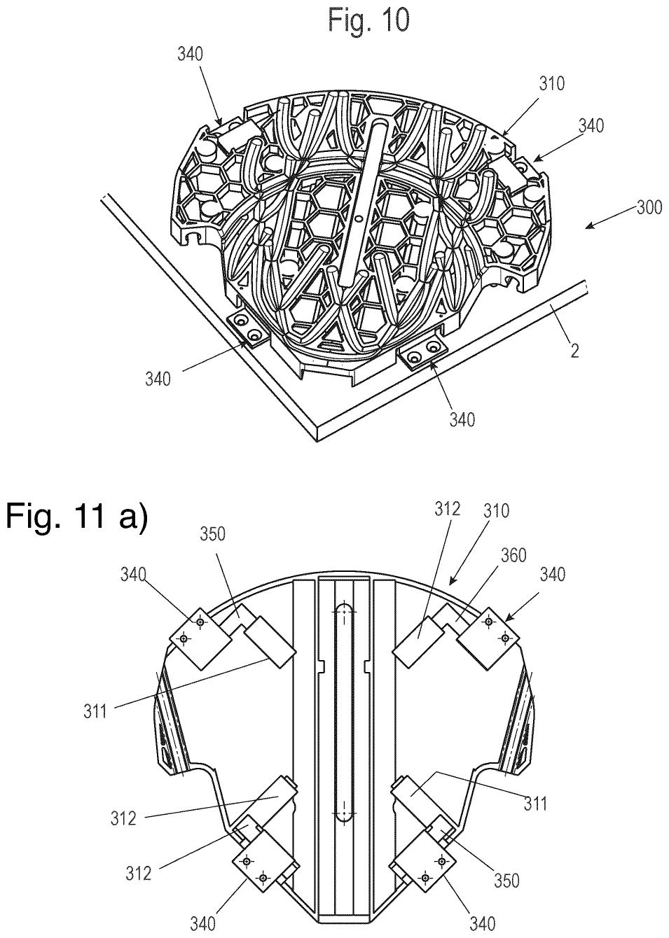

In the embodiment variant of the translational-rotational fitting 300 shown in FIGS. 10-13, the adjustment arrangement has two first L-shaped sliding elements 350 held on the first body 2 so as to be displaceable in the first adjusting direction x and two second L-shaped sliding elements 360 held on the first body 2 so as to be displaceable in the second adjusting direction y, the first sliding elements 350 being aligned perpendicular to the second sliding elements 360.

Here, too, the actual translational-rotational fitting with the first fitting plate 310 and a second fitting plate not shown here is designed analogously to the embodiment variant described in FIGS. 1-6.

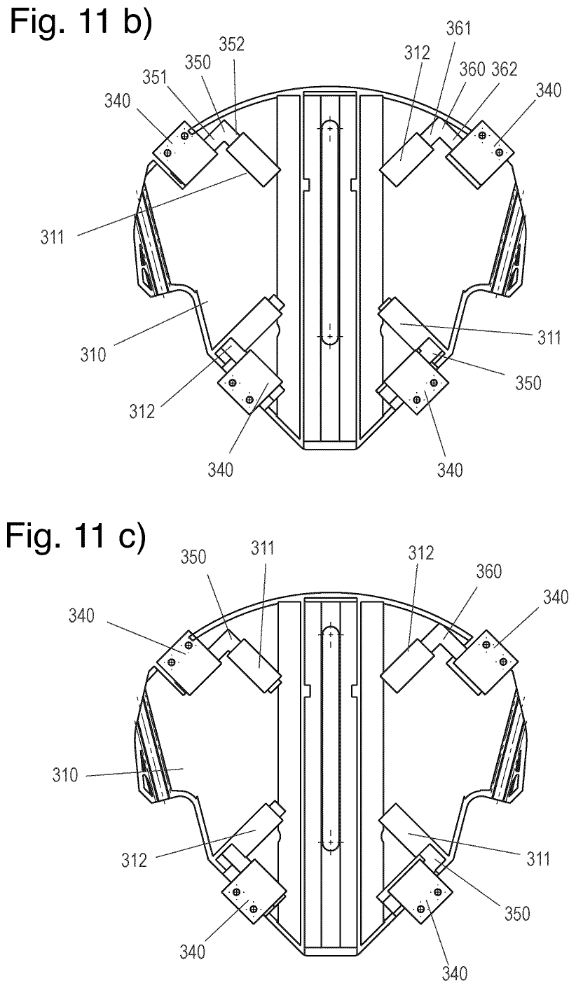

Only on the underside of the first fitting plate 310 facing the first body 2, as shown in FIG. 11, are guide bushes 311, 312 formed or attached, in each of which the second leg 352, 362 of the L-shaped sliding elements 350, 360 is received and can be displaced in the longitudinal direction of the respective guide bush 311, 312.

The respective first leg 351, 361 is preferably aligned perpendicular to the respective second leg 352, 362 of the respective sliding element 350, 360.

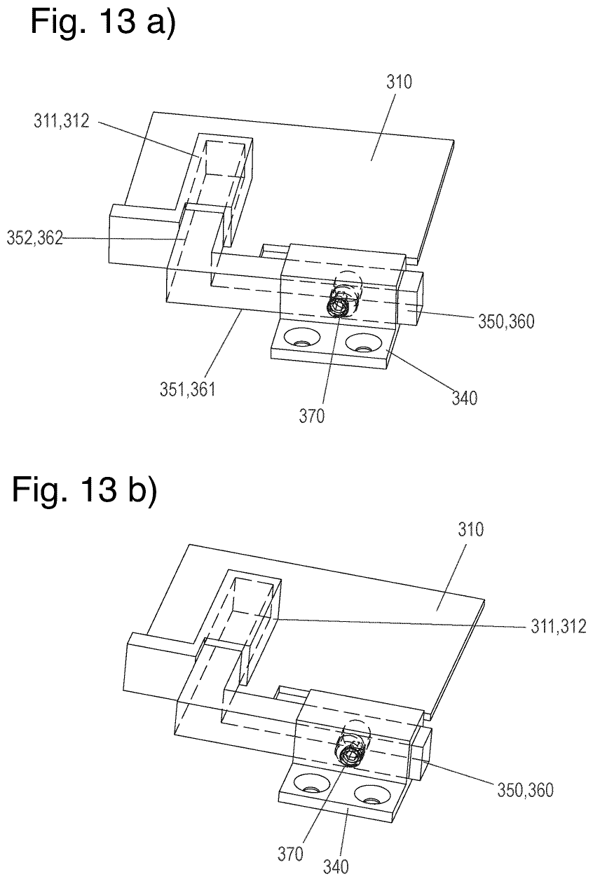

The first legs 351, 361 of the sliding elements 350, 360 are accommodated in retaining elements 340 attached to the first body 2. The retaining elements 340 also have guide bushes for guiding the first legs 351, 361, as shown by way of example in FIGS. 13a and 13b.

In order to align the first fitting plate 310 relative to the first body 2, the sliding elements 350, 360 are slidably received in the retaining elements 340 attached to the first body 2 by means of adjusting screws 370.

In the embodiment variant shown in FIGS. 13a and 13b, the adjusting screws 73 are designed as eccentric screws that project into elongated holes of a leg 351, 361 of the sliding elements 350, 360 projecting into the respective retaining element 340, so that a linear displacement movement in the direction of the first leg 351 of the sliding elements 350, 360 is effected by turning the eccentric screw. Due to the perpendicular alignment of the second legs 352, 362, which are received in correspondingly aligned sleeves 311, 312 on the underside of the first fitting plate 310 facing the first body 2, the first fitting plate 310 is thus displaced in the direction of the longitudinal extension of the first leg 351, 361 of the respective sliding elements 350, 360.

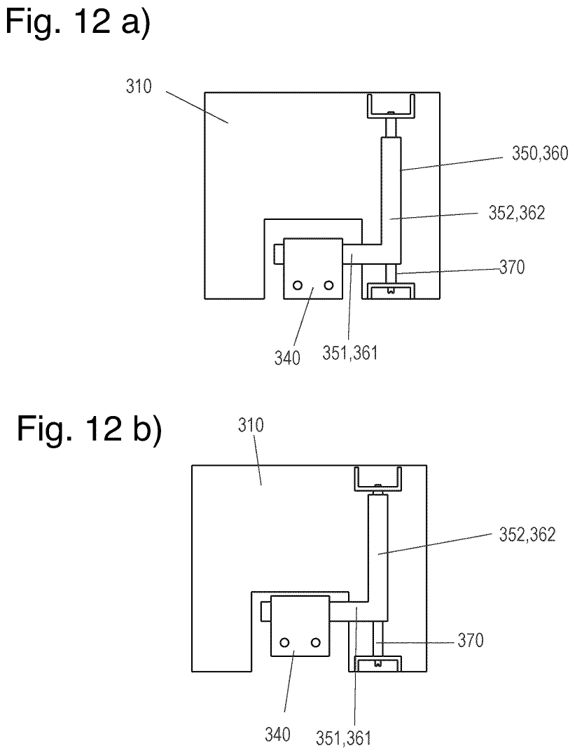

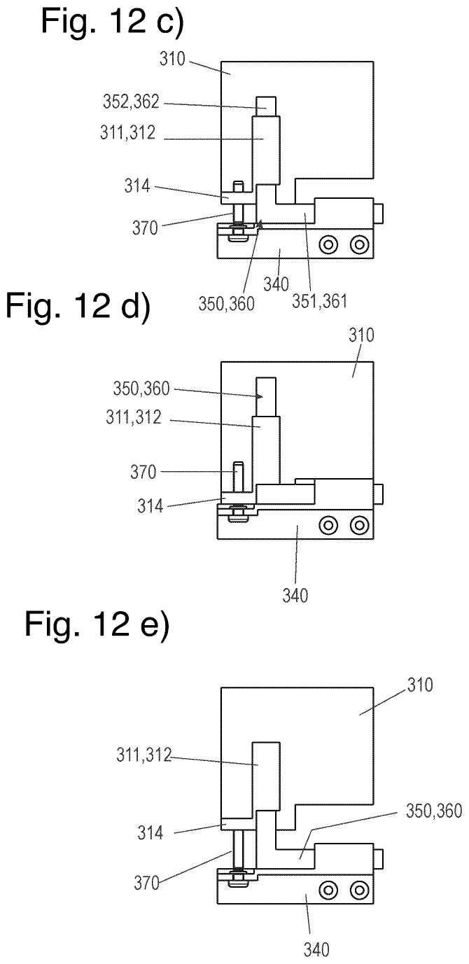

FIGS. 12a-12e show different displacement positions of the first fitting plate 310 relative to the retaining elements 340 fixed in a stationary position on the first body 2. In this embodiment, instead of the adjusting screws 370 designed as eccentric screws, adjusting screws 370 are shown in FIGS. 12a and 12b, which extend through the second leg 352, 362 of the respective sliding element 350, 360, the second legs 352, 362 being provided here with internal threads, so that a translational movement of the sliding element 350, 360 in the direction of the longitudinal extension of the second leg 352, 362 is effected by turning the adjusting screws 370. The adjusting screw 370 is held stationary but rotatable on the first fitting plate 310.

In the alternative embodiment according to FIGS. 12c, 12d and 12e, the adjusting screw 370 engages in a threaded bore of a collar 314 of the first fitting plate 310 in a similar manner to the embodiment shown with reference to FIGS. 1-6 and is fixed in a stationary but rotatable manner on the retaining element 340 by its head or a collar piece.

FIG. 12c shows a middle or neutral position of the adjustment arrangement, while FIGS. 12d and 12e show the respective maximum adjustment positions.

FIGS. 11a-11c also show respective different adjustment positions of the first fitting plate 310 relative to the retaining elements 340 fixedly attached to the first body 2.

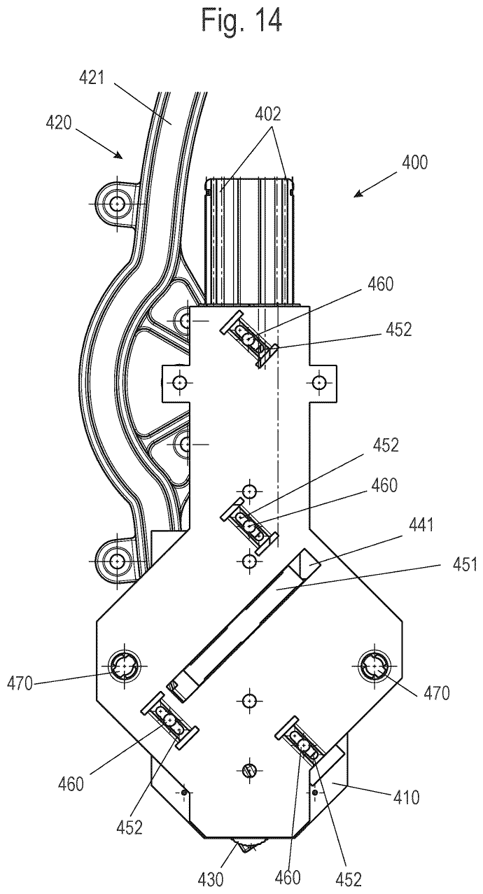

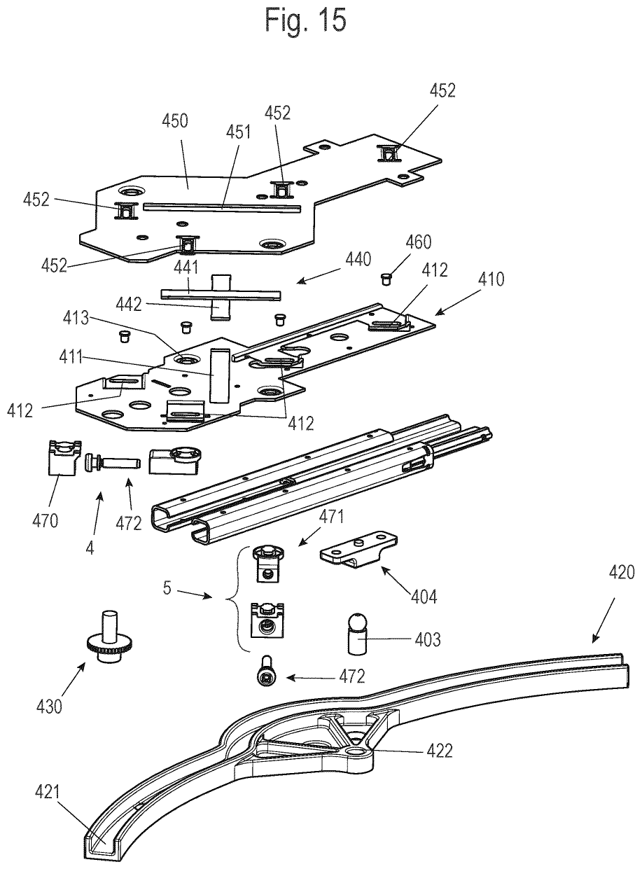

In the once again alternative embodiment shown in FIGS. 14-16b, a guide element 430 is arranged on the first fitting plate 410 for simultaneous translational-rotational movement, which is movable in a curved guide track 421 arranged on or in the second fitting plate 420. The translational movement is thereby guided by an extension guide, which is rotatably fixed to the second fitting plate 420, with preferably two guide rails 401 and running rails 402 which are displaceably guided therein in the translational direction A, as shown in FIG. 15. A rotation bearing 403 is received in a corresponding receptacle 422 of the second fitting plate 420 and coupled to the running rails 402 of the extension guide via a coupling piece 404.

As further shown in FIGS. 14, 15, 16a and 16b, in this embodiment of the translational-rotational fitting 400, the sliding element is designed as a guide cross 440 with a first web 441 aligned in the first adjusting direction x and a second web 442 aligned in the second adjusting direction y, analogous to the embodiment described with reference to FIGS. 7-9.

The first web 441 is accommodated in a groove 451 of a base plate 450 attached to the first body 2 so as to be displaceable in the first adjusting direction x. The second web 442 is guided in a groove 411 of the first fitting plate 410.

In this embodiment variant, too, the adjusting units 4, 5 used in the embodiment variant described in FIGS. 7-9 are preferably used, which each have two adjusting bodies 470, 471 connected to one another by a respective adjusting screw 472, the distance between which can be adjusted by turning the adjusting screw 472.

A first adjusting body 470 is attached here to the base plate 450, while the respective second adjusting body 471 is attached to the fitting plate 410. The alignment of the adjusting units 4, 5 also refers here to the alignment of the longitudinal axis of the adjusting screws 472, with the adjusting screw of the first adjusting unit 4 being aligned orthogonally to the adjusting screws 472 of the second adjusting unit 5.

As further shown in FIGS. 14 and 15, the base plate 450 and the first fitting plate 410 have respective guide slots 412, 452 for receiving rivets 460 fixing the base plate 450 and the first fitting plate 410 to each other in a direction z perpendicular to the plane of the base plate 450. The guide slots 412, 452 each extend in one of the positioning directions x, y, wherein partially overlapping guide slots 412, 452, through which a common rivet 460 is passed, are aligned in different ones of the positioning directions x, y.

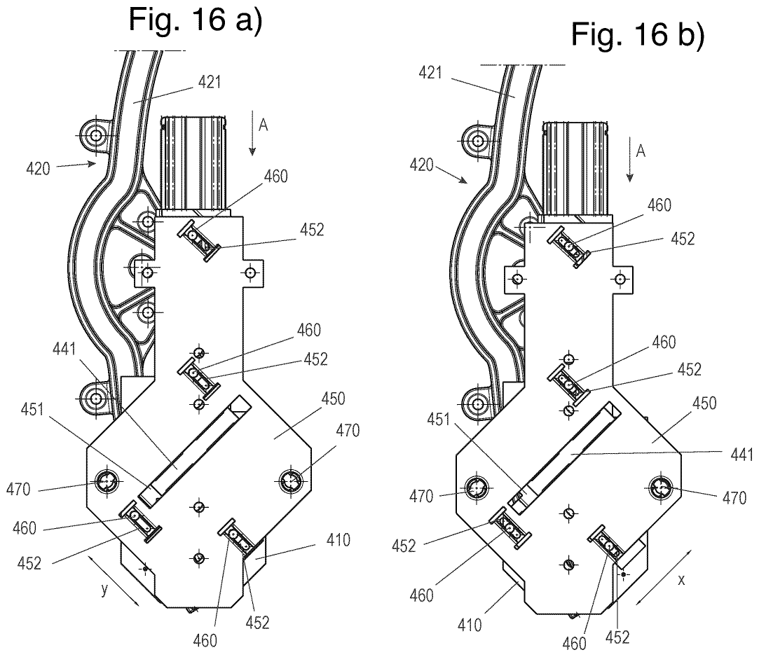

FIGS. 16a and 16b show different relative positions of the base plate 450, which in this case is preferably fixed to the second body 3, relative to the first fitting plate 410.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### List of Reference Symbols

1 Furniture or household appliance element
2 First body
3 Second body
4 Adjusting unit
5 Adjusting unit
100 Translational-rotational fitting
101 First retaining element
102 Second retaining element
103 Head
104 First adjusting screw
105 Second adjusting screw
110 First fitting plate
111 Collar
112 Running groove
113 Guide pin
114 Carriage
120 Second fitting plate
122 Running groove
130 Rolling element cage
131 Rolling elements
140 Base plate
141 Elongated hole
142 First collar
143 Second collar
144 Bulge
145 Elongated hole
150 First holder
151 Stop
152 Through hole
160 Second holder
200 Translational-rotational fitting
210 First fitting plate
220 Second fitting plate
240 Guide cross
241 First web
242 Second web
250 Base plate
251 Groove
252 Cover plate
260 Sliding plate
261 Groove
270 First adjusting body
271 Second adjusting body
272 Adjusting screw
273 Groove
274 Groove
300 Translational-rotational fitting
310 First fitting plate
311 Guide bush
312 Guide bush
314 Collar
320 Second fitting plate
340 Retaining element
350 Sliding element
351 First leg
352 Second leg
360 Sliding element
361 First leg
362 Second leg
370 Adjusting screw
400 Translational-rotational fitting
401 Guide rail
402 Running rail
403 Rotation bearing
404 Coupling piece
410 First fitting plate
411 Groove
412 Guide slot
420 Second fitting plate
421 Guide track
422 Receptacle
430 Guide element
440 Guide cross
441 First web
442 Second web
450 Base plate
451 Groove
452 Guide slot
460 Rivet
470 Adjusting body
471 Adjusting body
472 Adjusting screw
x Adjusting direction
y Adjusting direction
z Direction
R1, R2 Direction of rotation
A Direction of translation

1-17. (canceled)

18. A translational-rotational fitting configured for at least partially constrained simultaneous translational-rotational movement of a first body relative to a second body in one of two possible opposite directions of rotation and in a predetermined direction of translation, the translational-rotational fitting comprising:
a first fitting plate coupled to the first body;
a second fitting plate coupled to the second body and simultaneously movable in translation and rotation relative to the first fitting plate; and
at least one adjustment arrangement displaceably fixed on the first fitting plate and configured to independently align the first fitting plate relative to the first body in two mutually perpendicular adjusting directions in a plane of the translational-rotational movement of the first body relative to the second body by a limited adjustment dimension.

19. The translational-rotational fitting of claim 18, wherein the adjustment arrangement comprises:
a sliding element held displaceably on the first body in the first adjusting direction, wherein the sliding element is held displaceably on the first fitting plate in the second adjusting direction; and
at least two adjusting units configured to adjust the first fitting plate in the first adjusting direction and the second adjusting direction.

20. The translational-rotational fitting of claim 19, wherein the sliding element is a base plate with a plurality of first elongated holes aligned in the first adjusting direction and a plurality of second elongated holes aligned in the second adjusting direction, wherein first retaining elements fastened to the first body are guided through the first elongated holes and second retaining elements fastened to the first fitting plate are guided through the second elongated holes, wherein the first and second retaining elements are bolts or screws.

21. The translational-rotational fitting of claim 20, wherein the base plate has a first collar with a threaded bore in operative connection with the first adjusting unit and aligned perpendicularly to the first actuating direction, and a second collar with a threaded bore in operative connection with the second adjusting unit and aligned perpendicularly to the second actuating direction, and a first adjusting screw held in a fixed position on the first body is received in the threaded bore of the first collar and a second adjusting screw held in a fixed position on the first fitting plate is received in the threaded bore of the second collar.

22. The translational-rotational fitting of claim 19, wherein the sliding element is a guide cross with a first web aligned in the first actuating direction and a second web aligned in the second actuating direction, wherein the first web is received in a groove of a base plate fastened to the first body so as to be displaceable in the first adjusting direction and the second web is guided in a groove of a sliding plate fastened to the first fitting plate.

23. The translational-rotational fitting of claim 22, wherein the at least two adjusting units are fixedly secured to the base plate and the sliding plate.

24. The translational-rotational fitting of claim 23, wherein the at least two adjusting unit each have two adjusting bodies connected to one another by a respective adjusting screw, and wherein a distance between the respective two adjusting bodies is adjustable by turning the respective adjusting screw.

25. The translational-rotational fitting of claim 23, wherein the groove of the sliding plate fastened to the first fitting plate is covered with a cover plate fixed to the base plate.

26. The translational-rotational fitting of claim 18, wherein the adjustment arrangement comprises:
two first L-shaped sliding elements held displaceably on the first body in the first adjusting direction; and
two second L-shaped sliding elements held displaceably on the first body in the second adjusting direction,
wherein the two first L-shaped sliding elements are aligned perpendicular to the two second L-shaped sliding elements.

27. The translational-rotational fitting of claim 26, wherein the two first and the two second L-shaped sliding elements are displaceably received by adjusting screws in retaining elements fastened to the first body.

28. The translational-rotational fitting of claim 27, wherein the adjusting screws are eccentric screws projecting into elongated holes of a leg of the two first and the two second L-shaped sliding elements projecting into the respective retaining element.

29. The translational-rotational fitting of claim 18, wherein the first fitting plate and the second fitting plate each have running grooves in mutually facing bearing surfaces, in which rolling elements are guided, for simultaneous translational-rotational movement.

30. The translational-rotational fitting of claim 19, wherein the sliding element is a guide cross with a first web aligned in the first actuating direction and a second web aligned in the second actuating direction, wherein the first web is received in a groove of a base plate fastened to the first body so as to be displaceable in the first adjusting direction and the second web is guided in a groove of the first fitting plate.

31. The translational-rotational fitting of claim 30, wherein the at least two adjusting units each have two adjusting bodies connected to one another by a respective adjusting screw, a distance between the two adjusting bodies is adjustable by turning the adjusting screw, wherein a first adjusting body is fastened to the first fitting plate, a second adjusting body is fastened to the base plate, and the adjusting screws are aligned orthogonally to one another.

32. The Translational-rotational fitting of claim 31, wherein the base plate and the first fitting plate have respective guide slots configured to receive rivets fixing the base plate and the first fitting plate to each other in a direction perpendicular to the plane of the base plate, which extend in one of the positioning directions, wherein partially overlapping guide slots are aligned in different ones of the first and second positioning directions.

33. The translational-rotational fitting of claim 31, further comprising:
a guide element arranged on the first fitting plate and configured to perform simultaneous translational-rotational movement, wherein the guide element is movable in a curved guide track arranged on or in the second fitting plate.

34. A furniture or household appliance element comprising:
a first body;
a second body movable relative to the first body; and
a translational-rotational fitting configured to move the second body relative to the first body in a predetermined direction of translation and simultaneously in one of two possible opposite directions of rotation, wherein the translational-rotational fitting comprises
a first fitting plate coupled to the first body;
a second fitting plate coupled to the second body and simultaneously movable in translation and rotation relative to the first fitting plate; and
at least one adjustment arrangement displaceably fixed on the first fitting plate and configured to independently align the first fitting plate relative to the first body in two mutually perpendicular adjusting directions in a plane of the translational-rotational movement of the first body relative to the second body by a limited adjustment dimension.
